(19) United States
(12) Patent Application Publication
(10) Pub. No.: US 2014/0002784 A1
(43) Pub. Date: Jan. 2, 2014

(54) HEAT DISSIPATION CONSTRUCTION FOR INDOOR-OUTDOOR LCD SIGN BOARD

(71) Applicant: Chae Won Bang, Cresskill, NJ (US)

(72) Inventor: Chae Won Bang, Cresskill, NJ (US)

(21) Appl. No.: 13/534,425

(22) Filed: Jun. 27, 2012

(51) Int. Cl. G02F 1/1333

(52) U.S. Cl. 349/161

(57) ABSTRACT

A heat dissipation structure for an indooroutdoor LCD signboard, which includes an LCD panel and a backlight unit. The heat dissipation structure includes a frame supporting the LCD panel, a cover coupled to a rear surface of the frame, the cover supporting the backlight unit, a heatblocking means provided on the frame to prevent heat generated by the backlight unit from being transferred forward, and a heatdissipating means provided on the cover to dissipate the heat generated by the backlight unit backward. The structure can efficiently perform heat dissipation function irrespective of installation location, such as an indoor or outdoor location, thereby increasing endurance while maintaining the reliability of operation.

### BACKGROUND OF THE INVENTION

1. Field of the Invention

The present invention relates, in general, to an indooroutdoor LCD signal board, and more particularly, to a heat dissipation structure for an indooroutdoor LCD signal board that can efficiently carry out its heat dissipation function irrespective of installation location, such as an indoor or outdoor location.

2. Description of the Related Art

Generally, Digital Information Displays (DIDs) refer to digital display devices that are intended to reproduce information or commercial content. DIDs are mainly based on a highluminance liquid crystal display (LCD) or a plasma display panel (PDP) technology or other types of display technology. In the field of DIDs, there is intense technological competition to satisfy the trends of largesize and highluminance. In particular, as for LCD signboards using an LCD, the development of a technology for preventing an LCD panel from losing quality or being damaged by heat generated by a highpower backlight unit is urgent.

As previously filed patents relating to this, “CASSETTE-TYPE DISPLAY MODULE FOR ELECTRONIC DISPLAY BOARD THAT HAS HIGH HEAT DISSIPATION AND WATERTIGHT PERFORMANCE” disclosed in Korean Patent No. 0749722, “DIGITAL ELECTRONIC DISPLAY BOARD HAVING LCD AND LED PANEL COOLING MODULE” disclosed in Korean Patent No. 0969937, and the like are known.

Korean Patent No. 0749722 relates to a display module for an electronic display board, and proposes a construction that includes a housing having an open front side, a plurality of lightemitting lamps disposed inside the housing, a circuit board electrically connected to the lightemitting lamps, a module body having an area through which the lightemitting lamps extend and having heatdissipating vent holes formed at regular intervals, a silicone molding disposed inside the module body to provide watertight seal, and a protective cover, which opens and closes the open front surface of the module body. Accordingly, attachment/detachment performance and replacement performance are excellent, the heatdissipating vent holes minimize the high heat generated by the module, and the effect of increasing the waterproof performance using the silicone molding is expected.

Korean Patent No. 0969937 proposes a construction that includes a body, an LCD and LED panel, and a cooling module. The body is provided with a front display window, air inlets in the lower ends of the front and rear surfaces, and air outlets in the upper end and the middle portion of the rear surface. In the air outlets, a blocking piece, which restricts a passage along which air flows, is provided. The LCD and LED panel is fixedly provided in the rear of the display window of the body. The cooling module is provided with a fixing plate directly below the LCD and LED panel inside the body, a thermoelectric element provided in each vent hole of the fixing plate, a heat dissipation plate provided in front of each thermoelectric element, front and rear covers provided on the front and rear surfaces of the fixing plate, the covers being open in the upper and lower portions thereof, and blower fans provided on lower end portions between the fixing plate and the front cover and between the fixing plate and the rear cover. This construction prevents the temperature of the panel from becoming excessively high, so that the effect of preventing the electronic display board from breaking down due to the overheating of the LCD and LED panel is expected.

Although the function of dissipating heat from the display of the electronic display board can be expected to a certain degree from the abovedescribed Patents, which were previously filed, it is insufficient to cope with the conditions of abrupt environmental variation when the signboard is provided such that it is carried between indoor and outdoor places.

### SUMMARY OF THE INVENTION

Accordingly, the present invention has been made keeping in mind the above problems occurring in the related art, and purposes of the present invention are to propose a heat dissipation structure for an indooroutdoor LCD signal board that can efficiently perform heat dissipation function irrespective of installation location, such as an indoor or outdoor location, thereby increasing endurance while maintaining the reliability of operation.

In order to achieve the above objects, according to one aspect of the present invention, there is provided a heat dissipation structure for an indooroutdoor LCD signboard, which includes an LCD panel and a backlight unit. The heat dissipation structure includes a frame supporting the LCD panel; a cover coupled to a rear surface of the frame, the cover supporting the backlight unit; a heatblocking means provided on the frame to prevent heat generated by the backlight unit from being transferred forward; and a heatdissipating means provided on the cover to dissipate the heat generated by the backlight unit backward.

According to an embodiment of the invention, the inner surface of the cover may have a projection and an exhaust port formed therein in order to prevent moisture from penetrating while supporting the backlight unit.

According to an embodiment of the invention, the heat-blocking means may include a tempered glass plate via a holder in order to block heat transfer while allowing light to pass through.

According to an embodiment of the invention, the heatblocking means may include an infrared filter.

According to an embodiment of the invention, the heatdissipating means may include an intake port, an exhaust port, the intake and exhaust ports being formed in the cover, and an intake fan over the intake port.

Consequently, according to embodiments of the invention, the heat dissipation function can be efficiently performed irrespective of installation location, such as an indoor or outdoor location, thereby increasing endurance while maintaining the reliability of operation.

### BRIEF DESCRIPTION OF THE DRAWINGS

The above and other objects, features and further advantages of the present invention will be more clearly understood from the following detailed description when taken in conjunction with the accompanying drawings, in which:

FIG. 1 is an exploded perspective view showing the state to which a heat dissipation structure of the invention is applied; and

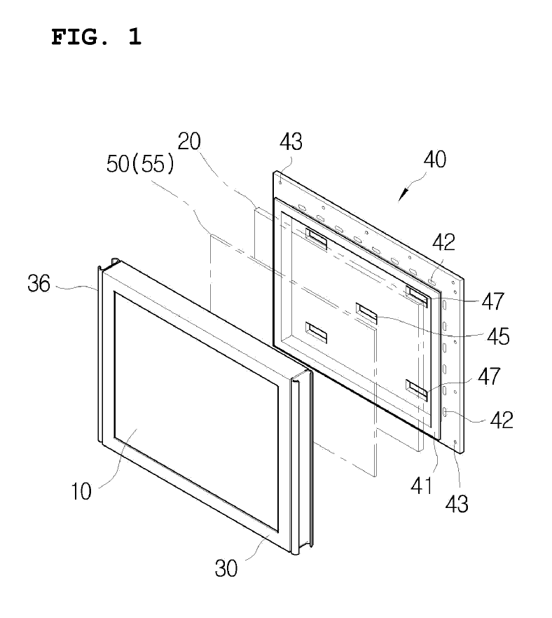

FIG. 2 is a configuration view showing the state in which the heat dissipation structure of the invention operates.

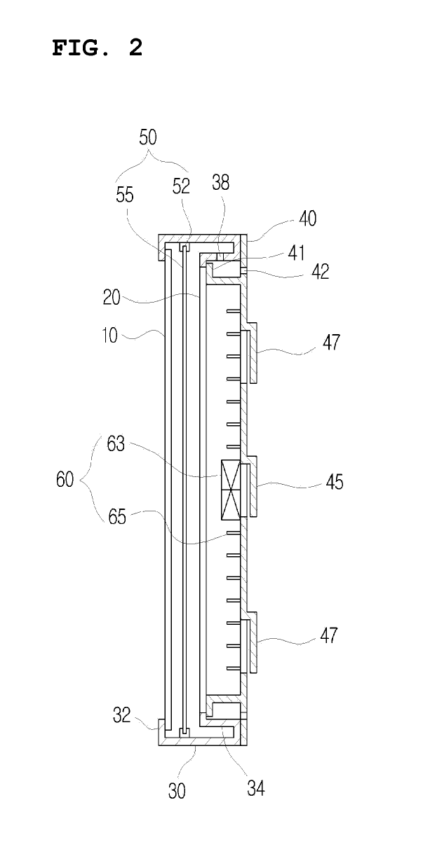

### DETAILED DESCRIPTION OF THE INVENTION

Reference will now be made in detail to the present invention, embodiments of which are illustrated in the accompanying drawings.

The present invention relates to an LCD signboard having an LCD panel 10 and a backlight unit 20. In particular, the invention is suitably applied to the case in which the signboard is frequently moved between indoor and outdoor locations or is constantly installed outdoors where the environmental conditions are hostile. The invention has been devised from the point of view that, in the signboard, heat generated by the backlight unit 20 acts as a factor that lowers not only the quality of images of the LCD panel 10 but also the endurance.

According to an embodiment of the invention, a frame 30, which supports the LCD panel 10, is provided. The frame 30 is configured such that it has front and rear bent sections 32 and 34, which extend forward and backward respectively. The LCD panel 10 is fixed on the front bent section 32 having an Lshaped crosssection. The rear bent section 34 is a portion that fixes a cover 40, which will be described later, and has a Cshaped crosssection, which is to be brought close to a projection 41 of a cover 40 at the time of assembly. A heat dissipation venthole 38 is formed in the upper portion of the rear bent section 34. Supports 36 are provided on sides of the frame 30 such that the structure can be fixed at an intended height in an indoor or location. A plurality of fastening holes is formed on the supports 36 such that an array of fastening holes is formed in the vertical direction.

In addition, according to the invention, the cover 40 is coupled to the rear surface of the frame 30 while supporting the backlight unit 20. The backlight unit 20 is mounted on the inner surface of the cover 40 such that a predetermined gap is formed between the backlight unit 20 and the LCD panel 10. The cover 40 is coupled to the open rear surface of the frame 30, with an airtight sealing (not shown) being interposed therebetween.

Here, the cover 40 is provided with the projection 41 and exhaust ports 42 in the inner surface thereof in order to prevent moisture from penetrating while supporting the backlight unit 20. The projection 41 is a member that is bent such as to form an Lshaped crosssection, and provides a rectangular structure that is attached to the inner surface of the cover 40. The outer dimensions of the projection 41, which define the rectangular shape, are set to the maximum values as long as they do not interfere with the bent sections 34 of the frame 30 during the assembly process. The exhaust ports 42 having the form of a slot are formed at regular intervals in the portions of the cover 40 that are most adjacent to the projection 41. With this configuration, heat from the inside is exhausted through the projection 41 and the exhaust ports 42, but external moisture (rain drops) is blocked from entering by the projection 41 so that it is discharged through the exhaust ports 42.

In the meantime, reference numeral 43, which was not yet described, indicates fastening holes through which the cover 40 is coupled to the rear bent section 34 of the frame 30 using a bolt. Although not shown, the rear bent section 34 of the frame 30 is also provided with corresponding fastening holes and nuts.

In addition, according to the invention, a heatblocking means 50 is provided on the frame 30 in order to prevent heat generated by the backlight unit 20 from being transferred forwards. Although the heatblocking means 50 blocks radiation heat and convection heat that are generated by the backlight unit, light rays from the backlight unit 20 must pass towards the LCD panel 10.

As such, the heatblocking means 50 has a tempered glass plate 55 via holders 52 in order to block heat transfer while allowing light to pass through. The holders 52 are fixed to the frame 30 using a resin material that has heatinsulating and heat resistant properties, and support the tempered glass plate 55 so that the tempered glass plate 55 stays at a predetermined gap from the LCD panel 10 and the backlight unit 20. The tempered glass plate 55 may be configured to have multiple layers in order to increase heat insulation.

In the meantime, according to an embodiment of the invention, the heatblocking means 50 may be provided with an infrared (IR) filter. The IR filter may be provided in place of the tempered glass plate 55, and both the tempered glass plate 55 and the IR filter may be provided.

In addition, according to an embodiment of the invention, a heatdissipating means 60 is provided on the cover 40 in order to dissipate heat from the backlight unit 20 backward. The heatdissipating means 60 serves to dissipate heat from the backlight unit 20, which acts as a heat source, and cooperates with the heatblocking means 50 in order to prevent the LCD panel 10 from overheating in response to the surrounding environment, e.g. the temperature thereof.

Here, it is preferable that the heatdissipating means 60 form an intake port 45 and exhaust ports 47 in the cover 40 and be provided with an intake fan 63 over the intake port 45. The intake port 45 is formed in the central portion of the cover 40, and the exhaust ports 47 are formed in a plurality of points around the intake port 45. The intake port 45 and the exhaust ports 47 are configured so as to prevent moisture (rain drops) from penetrating inward. For example, a stationary louver structure or a movable damper structure may be applied. The intake fan 63, which is driven by a motor, is provided over the intake port 45.

As a modified embodiment of the invention, the heatdissipating means 60 may also include heatdissipating fins 65 on the inner surface of the cover 40. The heatdissipating fins 65 formed on the inner surface of the cover 40 increase the amount of the heat that is generated by the rear surface of the backlight unit 20 that is exhausted to the outside. The height of the heatdissipating fins 65 may be graded so as to cope with the temperature gradient of the backlight unit 20.

It is apparent to a person having ordinary skill in the art that the present invention is not limited to the abovedescribed embodiments but various changes and modifications are possible without departing from the spirit and scope of the invention. It is therefore to be understood that such changes and modifications should fall within the accompanying claims of the invention.

What is claimed is:

1. A heat dissipation structure for an indooroutdoor LCD signboard, which includes an LCD panel and a backlight unit, the heat dissipation structure comprising:
a frame supporting the LCD panel;
a cover coupled to a rear surface of the frame, the cover supporting the backlight unit;
a heatblocking means provided on the frame to prevent heat generated by the backlight unit from being transferred forward; and
a heatdissipating means provided on the cover to dissipate the heat generated by the backlight unit backward.

2. The heat dissipation structure of claim 1, wherein an inner surface of the cover has a projection and an exhaust port formed therein in order to prevent moisture from penetrating while supporting the backlight unit.

3. The heat dissipation structure of claim 1, wherein the heatblocking means comprises a tempered glass plate via a holder in order to block heat transfer while allowing light to pass through.

4. The heat dissipation structure of claim 1, wherein the heatblocking means comprises an infrared filter.

5. The heat dissipation structure of claim 3, wherein the heatblocking means comprises an infrared filter.

6. The heat dissipation structure of claim 1, wherein the heatdissipating means comprises an intake port, an exhaust port, the intake and exhaust ports being formed in the cover, and an intake fan over the intake port.
